(19) United States
(12) Patent Application Publication
(10) Pub. No.: US 2017/0147140 A1
(43) Pub. Date: May 25, 2017

(54) TOUCH PANEL DEVICE, INPUT DEVICE, AND TOUCH PANEL SYSTEM

(71) Applicant: Panasonic Intellectual Property Management Co., Ltd., Osaka (JP)

(72) Inventors: Naoki KOSUGI, Kyoto (JP); Takashi KITADA, Osaka (JP); Masayuki OYAMADA, Osaka (JP)

(21) Appl. No.: 15/427,495

(22) Filed: Feb. 8, 2017

Related U.S. Application Data
(63) Continuation of application No. PCT/JP2015/004786, filed on Sep. 18, 2015.

(30) Foreign Application Priority Data
Mar. 12, 2015 (JP) 2015-050020
Sep. 26, 2016 (JP) 2014-196563

(51) Int. Cl. G06F 3/041; G06F 3/0354; G06F 1/16; G06F 3/044

(52) U.S. Cl. CPC G06F 3/0416; G06F 3/044; G06F 3/0412; G06F 3/03545; G06F 1/163; G02F 1/13338

(57) ABSTRACT

A touch panel system includes electronic pens and a touch panel. In the touch panel, a touch sensor detects a touch position that each of the electronic pens touches. A signal control device controls the touch sensor so as to transmit a reference signal indicating reference timing to the touching electronic pen, and to receive a response signal from the electronic pen. In each of the electronic pens, a reception electrode receives the reference signal from the touch panel. A timing generation circuit generates the response signal having a delay period of a predetermined value from the reference timing. A transmission electrode transmits the response signal to the touch panel through the touch sensor. The signal control device identifies the touching electronic pen, based on the delay period of the response signal received from each of electronic pens.

### BACKGROUND

1. Technical Field

The present disclosure relates to a touch panel device, an input device, and a touch panel system including the same.

2. Description of the Related Art

A touch panel device having a screen input function of inputting information by touch operation on a display screen with a finger of a user or the like has been used for a stationary customer guidance terminal such as mobile electronic device including a personal digital (data) assistant (PDA), a portable terminal and the like, various home electric appliances, an unmanned reception machine and the like. The touch operation to the above-described touch panel device is normally performed by the user touching with a finger or the like, or by using an input device such as an electronic pen or the like. As a touch detection method in the above-described touch operation, an electrostatic capacity coupling method of detecting capacity change has been known. For example, a touch panel device as in Patent Literature 1 has been known.

Unexamined Japanese Patent Publication No. 2012-160172 has disclosed a technique in which noise is removed to decide a valid touch level, corresponding to distribution of a number of panel points to an input touch level, and neighboring touches on a touch panel are separated, based on the decided valid touch level, by which one or more touch points are decided. This enables a plurality of touches to be separated and detected.

### SUMMARY

The present disclosure provides a touch panel device, input devices, and a touch panel system capable of identifying touch operation by individual input devices when the touch operation is performed to one touch panel device by the different input devices.

A touch panel system according to the present disclosure includes a plurality of input devices, and a touch panel device. Each of the touch panel devices transmits a reference signal, and adds a delay to the reference signal to transmit a response signal to the touch panel device. The delay differs, depending on the individual input device, so that this delay allows the touch panel device to identify the plurality of input devices.

According to the present disclosure, when touch operation is performed by the different input devices, the touch operation by the individual input devices can be identified.

### BRIEF DESCRIPTION OF THE DRAWINGS

FIG. 1 a schematic diagram showing an overview of a touch panel system according to a first exemplary embodiment;

FIG. 2 is a block diagram showing an entire configuration of touch panel;

FIG. 3 is a diagram showing one example of arrays of drive electrodes and sensing electrodes configuring touch sensor;

FIG. 4 is a block diagram showing a configuration of electronic pen in the first exemplary embodiment;

FIG. 5A is a diagram for describing a schematic configuration of touch sensor in a state where touch operation is not performed;

FIG. 5B is a diagram for describing an equivalent circuit of touch sensor in the state where the touch operation is not performed;

FIG. 5C is a diagram for describing the schematic configuration of touch sensor in a state where the touch operation is performed;

FIG. 5D is a diagram for describing the equivalent circuit of touch sensor in the state where the touch operation is performed;

FIG. 6 is a diagram showing change of a detection signal when the touch operation is not performed, and when the touch operation is performed;

FIG. 7 is a diagram for describing detection operation of a touch position by touch panel;

FIG. 8 is a sequence diagram showing a flow of operation of the touch panel system;

FIG. 9 is a timing chart showing identification operation when a plurality of electronic pens touches touch panels;

FIG. 10 is a graph showing one example of a sensing result of the response signal from electronic pen in touch panel;

FIG. 11 is a graph showing one example of a signal intensity of a drive signal that electronic pen receives; and

FIG. 12 is a block diagram showing a configuration of wearable terminal in another exemplary embodiment.

### DETAILED DESCRIPTION

Hereinafter, referring to the drawings as needed, exemplary embodiments will be described in detail. However, more detailed description than needed may be omitted. For example, detailed descriptions of well-known items and overlapping descriptions of substantially the same configurations may be omitted. This is to avoid making the following description unnecessarily redundant, and to facilitate understanding of those in the art.

The inventors of the present disclosure provides accompanying drawings and the following description to help those in the art to understand the present disclosure, and this is not intended to limit subjects described in claims.

### First Exemplary Embodiment

Hereinafter, referring to the accompanying drawings, a first exemplary embodiment will be described.

### 1. Configuration

### 1-1. Overview of Touch Panel System

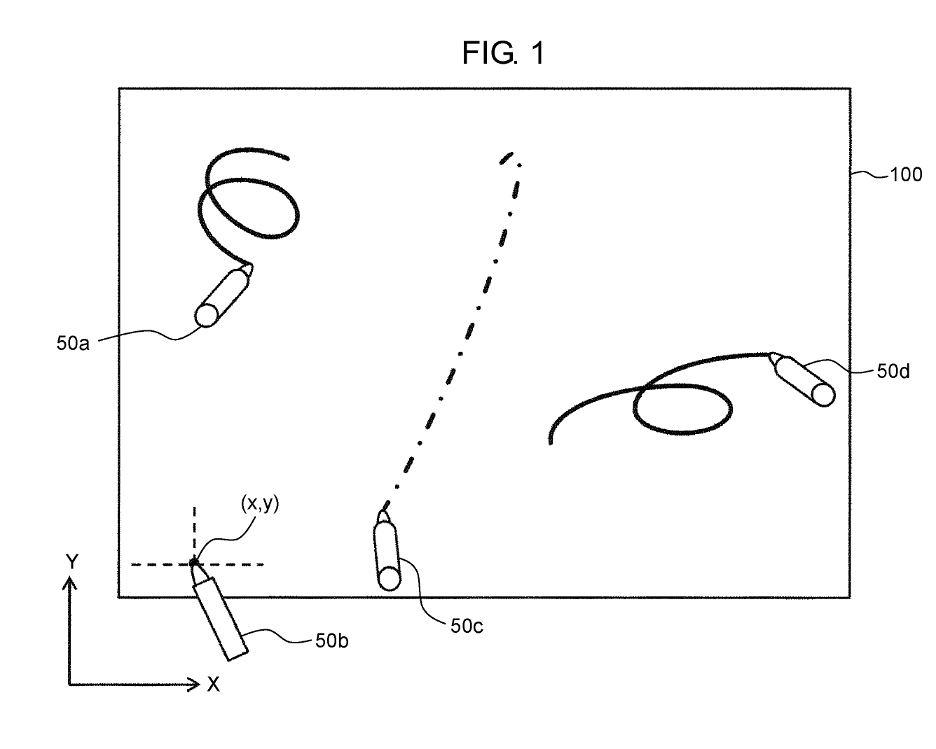

FIG. 1 is a schematic view showing an overview of a touch panel system according to the present exemplary embodiment. The touch panel system according to the present exemplary embodiment includes touch panel 100, and a plurality of electronic pens 50a, 50b, 50c, 50d (hereinafter, electronic pens 50a, 50b, 50c, 50d are collectively referred to as electronic pen(s) 50). The touch panel system is used, for example, as an electronic blackboard, and controls display of touch panel 100 in accordance with the touch operation of electronic pen 50. For example, an image is generated such that a line is drawn on touch panel 100 along a track of touch positions of electronic pen 50, and so on.

In the present exemplary embodiment, touch panel 100 is a liquid crystal display device having a function of detecting the touch operation by a touch (contact) of a finger of a user or electronic pen 50. Electronic pen 50 is a pen-type input device configured to input the touch operation in touch panel 100. Touch panel 100 identifies the touch operation by the plurality of electronic pens 50a to 50d (in the present example, four pens) to thereby perform display control to change, for example, a color of a line and a line type by each electronic pen 50. Hereinafter, configurations of touch panel 100 and electronic pen 50 configuring the touch panel system will be described.

### 1-2. Configuration of Touch Panel

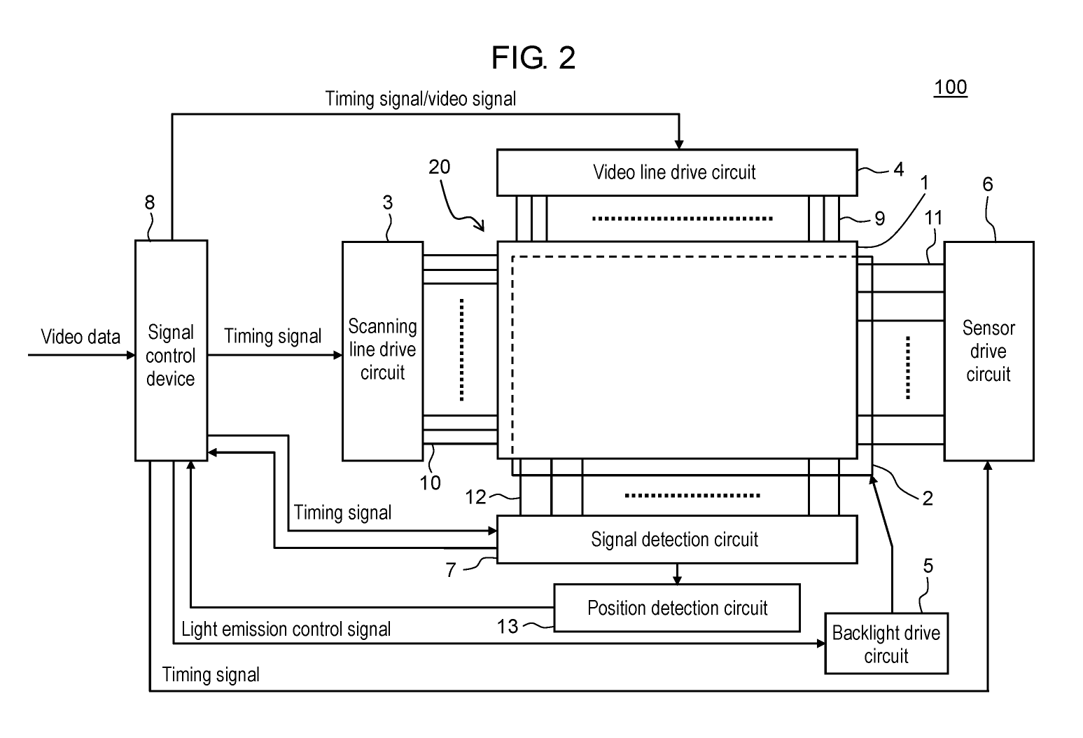

FIG. 2 is a block diagram showing an entire configuration of touch panel 100 in the first exemplary embodiment. Touch panel 100 includes display 1, backlight unit 2, scanning line drive circuit 3, video line drive circuit 4, backlight drive circuit 5, signal control device 8, and touch sensor 20.

Display 1 displays an image and characters in a display surface. Display 1 is configured by a plurality of liquid crystal panels. Display 1 may be configured by one liquid crystal panel. In the display surface of display 1, touch sensor 20 is formed so as to be superimposed, which implements a touch sensor function of detecting the touch operation to the image displayed on the display surface. Each of the liquid crystal panels of display 1 has a TFT substrate made of a transparent substrate such as a glass substrate and the like, and a counter substrate disposed with a predetermined gap provided so as to be opposed to this TFT substrate, and is configured by sealing a liquid crystal material between the TFT substrate and the counter substrate.

The TFT substrate is located on a back surface side of display 1. On the substrate configuring the TFT substrate, pixel electrodes arranged in matrix, thin film transistors (TFTs) as switching elements provided, corresponding to the pixel electrodes to perform on/off control of voltage application to the pixel electrodes, a common electrode and the like are formed.

Moreover, the counter substrate is located on a front surface side of display 1. On a transparent substrate configuring the counter substrate are formed color filters (CF) made of at least three primary colors of red (R), green (G), blue (B) at positions corresponding to the pixel electrodes, and a black matrix arranged between respective subpixels of RGB and/or between pixels configured by the subpixels in RGB and made of a light-shielding material for increasing contrast, and so on. In the present exemplary embodiment, a description will be given on the assumption that the TFT formed in each of the subpixels of the TFT substrate is an n channel TFT.

In the TFT substrate, a plurality of video signal lines 9 and a plurality of scanning signal lines 10 are formed roughly perpendicularly to one another. Scanning signal lines 10 are provided in a horizontal direction of the TFTs, and are commonly connected to gate electrodes of the plurality of TFTs. Video signal lines 9 are provided in a vertical direction of the TFTs, and are commonly connected to drain electrodes of the plurality of TFTs. The pixel electrode arranged in a pixel region corresponding to the TFT is connected to a source electrode of each of the TFTs.

Each of the TFTs formed in the TFT substrate is subjected to on/off operation control in a predetermined unit in accordance with a scanning signal applied to scanning signal lines 10. Each of the TFTs in a horizontal row controlled to be turned on sets the pixel electrode to a potential (a pixel voltage) in accordance with a video signal applied to video signal lines 9. Display 1 has the plurality of pixel electrodes and the common electrode provided so as to be opposed to these pixel electrodes. Orientation of the liquid crystal is controlled for each of the pixel regions by an electric field generated between the pixel electrode and the common electrode to change a transmittance with respect to light entering from backlight unit 2 and form the image on the display surface.

Backlight unit 2 is disposed on the back surface side of display 1, and applies light from a back surface of display 1, and for example, there have been known those having a structure in which a plurality of light emitting diodes are arrayed to configure a surface light source and those having a structure in which the light of the light emitting diodes is used as a surface light source by combining a light guiding plate and a diffuse reflection plate.

Scanning line drive circuit 3 is connected to the plurality of scanning signal lines 10 formed in the TFT substrate. Scanning line drive circuit 3 sequentially selects scanning signal lines 10 in accordance with a timing signal input from signal control device 8 to apply a voltage turning on the TFTs to selected scanning signal line 10. For example, scanning line drive circuit 3 includes a shift resistor. Upon receiving a trigger signal from signal control device 8, the shift resistor starts operation, and sequentially selects scanning signal lines 10 along a vertical scanning direction to output a scanning pulse to selected scanning signal line 10.

Video line drive circuit 4 is connected to the plurality of video signal lines 9 formed in the TFT substrate. Video line drive circuit 4 applies a voltage in accordance with a video signal representing a gradation value of each of the subpixels to each of the TFTs connected to the selected scanning signal line 10 in accordance with the selection of scanning signal line 10 by scanning line drive circuit 3. This allows the video signal to be written in the subpixels corresponding to selected scanning signal line 10.

Backlight drive circuit 5 causes backlight unit 2 to emit light at timing and with a luminance in accordance with a light emission control signal input from signal control device 8.

In the present exemplary embodiment, mutual capacity-type touch sensor 20 by an electrostatic capacity method is employed. Touch sensor 20 is configured by a plurality of drive electrodes 11 and a plurality of sensing electrodes 12. In the display surface of display 1, the plurality of drive electrodes 11 and the plurality of sensing electrodes 12 are arranged so as to intersect with one another. Drive electrodes 11 and sensing electrodes 12 are an example of first and second electrodes arranged so as to intersect with one another.

Touch sensor 20 configured by these drive electrodes 11 and sensing electrodes 12 performs response detection by input of an electric signal and electrostatic capacity change between drive electrodes 11 and sensing electrodes 12 to detect a contact (approach) of an object to the display surface. As an electric circuit configured to detect this contact, sensor drive circuit 6 and signal detection circuit 7 are provided.

Sensor drive circuit 6 is a circuit configured to generate an AC signal, and is connected to drive electrodes 11. For example, sensor drive circuit 6 has the timing signal input from signal control device 8, and sequentially selects drive electrodes 11 to supply drive signal Txv by a rectangular pulse voltage to selected drive electrode 11. For example, sensor drive circuit 6 includes a shift resistor as with scanning line drive circuit 3. The shift resistor receives a trigger signal from signal control device 8 to start operation, and sequentially selects drive electrodes 11 along the vertical scanning direction to supply drive signal Txv by a pulse voltage to selected drive electrode 11.

Drive electrodes 11 and scanning signal lines 10 are formed so as to extend in a row direction in a horizontal direction the TFT substrate, and are arrayed in a column direction in a vertical direction. Sensor drive circuit 6 and scanning line drive circuit 3 electrically connected to these drive electrodes 11 and scanning signal lines 10 are arranged on both sides in a width direction (the horizontal direction) of a display region where the pixels are arrayed, scanning line drive circuit 3 is arranged on one side in the width direction, and sensor drive circuit 6 is arranged on the other side. Both scanning line drive circuit 3 and sensor drive circuit 6 may be arranged on one side in the width direction of the display region, or may be drawn out in another direction by wiring around the panel or the like.

Signal detection circuit 7 is a detection circuit configured to detect the electrostatic capacity change, and is connected to sensing electrodes 12. Signal detection circuit 7 is provided with a detection circuit for each of sensing electrodes 12 to output the electrostatic capacity change detected in sensing electrodes 12 as detection signal Rxv. As another configuration example, one detection circuit is provided for a plurality of sensing electrode 12 groups, and in a plurality of times of the pulse voltage applied to drive electrodes 11, the detection of detection signal Rxv may be performed in time division for each of the plurality of sensing electrode 12 groups to output detection signal Rxv.

A contact position of the object on the display surface is found, based on a determination result as to which drive electrode 11 drive signal Txv has been applied to and at that time, at which sensing electrode 12 the signal by the contact has been detected. The intersection between drive electrode 11 to which drive signal Txv has been applied, and sensing electrode 12 from which detection signal Rxv has been obtained is found as the contact position by arithmetical operation. The arithmetical operation for finding the contact position may be performed by providing an arithmetical operation circuit inside the liquid crystal display device, or may be performed by an arithmetical operation circuit outside the liquid crystal display device.

Signal control device 8 includes an arithmetical operation processing circuit such as a CPU and the like, a memory such as a ROM, a RAM and the like, and implements functions thereof by executing a predetermined program. Signal control device 8 performs various types of image signal processing such as color adjustment and the like, based on the input video data, and generates an image signal indicating the gradation value of each of the subpixels to supply the image signal to video line drive circuit 4. Moreover, signal control device 8 generates and supplies timing signals to scanning line drive circuit 3, video line drive circuit 4, backlight drive circuit 5, sensor drive circuit 6, and signal detection circuit 7, based on the input video data. Moreover, signal control device 8 supplies a luminance signal for controlling a luminance of the light emitting diodes, based on the input video data as the light emission control signal to backlight drive circuit 5. The function of signal control device 8 may be implemented by an electronic circuit designed exclusively or a reconfigurable electronic circuit (an application specific integrated circuit (ASIC), a field programmable gate array (FPGA) or the like).

Signal control device 8 controls sensor drive circuit 6 to output, to drive electrodes 11, the signal to be transmitted to electronic pens 50, and controls signal detection circuit 7 to receive the signal from electronic pens 50 in sensing electrodes 12. Signal control device 8 is one example of a controller configured to control touch sensor 20 of touch panel 100.

Moreover, signal control device 8 has an internal memory made up of the ROM, the RAM, and the like. The internal memory beforehand stores an ID data table in which an ID of each of the plurality of electronic pens 50 and a delay period of a response signal of each of electronic pens 50 are associated with each other. Moreover, in the internal memory, scanning timing information indicating scanning timing of each of drive electrodes 11 is stored for each number of the plurality of drive electrodes 11.

Position detection circuit 13 detects a touch (contact) position on the display surface of display 1, using detection signal Rxv output from signal detection circuit 7. A detection method of the touch position will be described later. Position detection circuit 13 is one example of a position detector configured to detect the touch position in the touch panel device. The function of position detection circuit 13 may be implemented by signal control device 8.

Here, scanning line drive circuit 3, video line drive circuit 4, sensor drive circuit 6, signal detection circuit 7, and position detection circuit 13 are each configured by mounting semiconductor chips of the respective circuits on a flexible wiring board, a printed wiring board, or a glass substrate. Moreover, the circuit of each of scanning line drive circuit 3, video line drive circuit 4, sensor drive circuit 6, signal detection circuit 7, and position detection circuit 13 may be formed simultaneously with the TFTs and the like in the TFT substrate.

Moreover, touch panel 100 has a communicator (not shown) to perform wireless communication of a high frequency or the like with electronic pens 50. Communication means between electronic pens 50 and touch panel 100 is not limited to the wireless communication, but, for example, wireless connection using an optical signal, ultrasonic waves or the like may be used, or wired connection may be used.

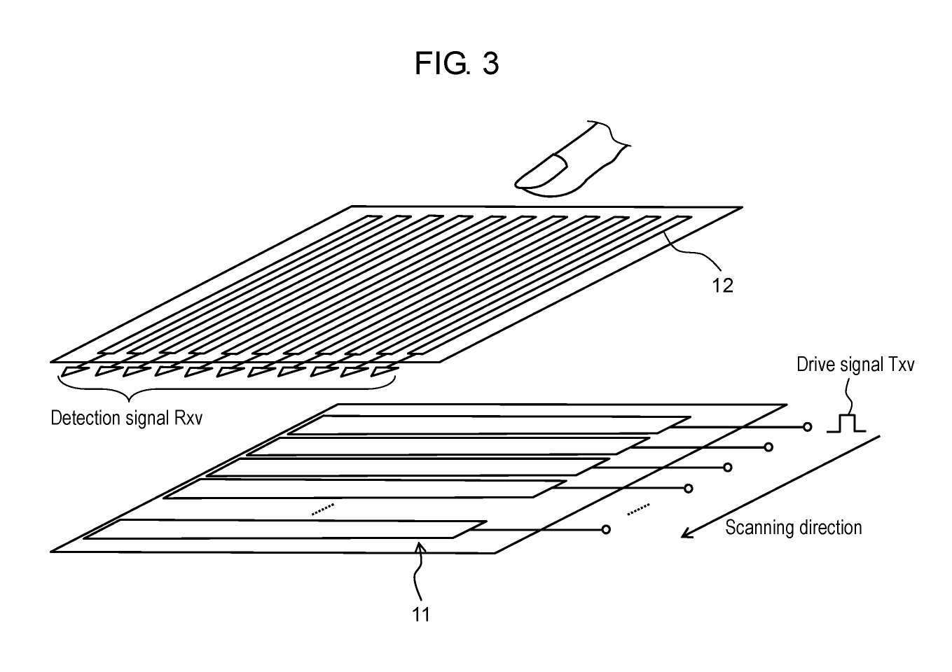

FIG. 3 is a diagram showing one example of arrays of the drive electrodes and the sensing electrodes configuring touch sensor 20. As shown in FIG. 3, touch sensor 20 is configured by drive electrodes 11, which are a plurality of stripe-like electrode pattern extending in the horizontal direction (right-left direction in FIG. 3), and sensing electrodes 12, which are a plurality of stripe-like conductors extending in a direction intersecting with the extension direction of conductors of drive electrode 11. At each of portions where drive electrodes 11 and sensing electrodes 12 intersect with one another, a capacitive element having an electrostatic capacity is formed.

### 1-3. Configuration of Electronic Pen

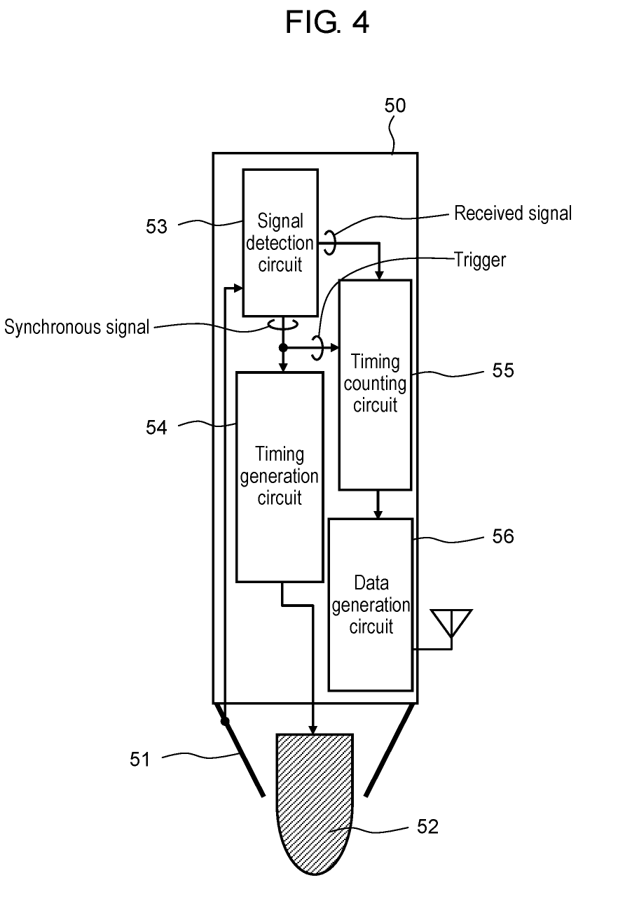

FIG. 4 is a block diagram showing a configuration of electronic pen 50 in the present exemplary embodiment. Electronic pen 50 includes reception electrode 51, transmission electrode 52, signal detection circuit 53, timing generation circuit 54, timing counting circuit 55, and data generation circuit 56. Electronic pen 50 is one example of an input device configured to input touch operation to touch panel 100.

Reception electrode 51 is an electrode to receive a signal from touch panel 100 near a pen point of electronic pen 50. Reception electrode 51 is formed so as to surround a periphery of transmission electrode 52 in non-electrical contact with transmission electrode 52. Reception electrode 51 is one example of a receiver configured to receive the signal from touch panel 100.

Transmission electrode 52 is an electrode to transmit a signal to touch panel 100 that the pen point of electronic pen 50 touches, for example, by changing a potential of the electrode itself. Transmission electrode 52 forms the pen point of electronic pen 50. Transmission electrode 52 is one example of a transmitter configured to transmit the signal to touch panel 100. While in the present exemplary embodiment, reception electrode 51 and transmission electrode 52 are provided at the pen point of electronic pen 50 as shown in FIG. 4, the dispositions of the respective electrodes are not limited to this, but for example, the dispositions of reception electrode 51 and transmission electrode 52 may be exchanged.

Signal detection circuit 53 is connected to reception electrode 51 to detect a signal received from reception electrode 51, based on change of a potential of reception electrode 51 or the like. Signal detection circuit 53 amplifies the detected signal and shapes a waveform of the same to output the resultant to timing generation circuit 54 and timing counting circuit 55.

Timing generation circuit 54 generates a timing signal having, for example, a pulse waveform after a delay period of a predetermined value has elapsed since input timing of a signal from signal detection circuit 53, and outputs the timing signal to transmission electrode 52. The delay period of the predetermined value is set, corresponding to the ID of the relevant electronic pen 50 one-to-one, and timing generation circuit 54 of electronic pen 50 having a different ID generates the timing signal having the different delay period. Timing generation circuit 54 is one example of a signal generator configured to generate the response signal to touch panel 100.

Timing counting circuit 55 has a counter circuit configured to start counting operation from a trigger, and counts an elapsed time from timing of the trigger to timing when the predetermined signal is input by signal detection circuit 53. Timing counting circuit 55 is one example of a timing counter configured to count timing when the drive signal is received from touch panel 100.

Data generation circuit 56 generates information regarding the touch operation such as elapsed time data indicating the counting of timing counting circuit 55 and the like. Data generation circuit 56 has an internal memory, in which ID information indicating the ID of relevant electronic pen 50 is stored. Data generation circuit 56 has a transmission antenna, and transmits information generated by wireless communication of a high frequency or the like together with the ID information to touch panel 100. The communication means between data generation circuit 56 and touch panel 100 is not limited to this, but for example, wireless communication using an optical signal, ultrasonic waves or the like may be used, or wired connection may be used.

Signal detection circuit 53, timing generation circuit 54, timing counting circuit 55, and data generation circuit 56 are each implemented, for example, separately or integrally by an electronic circuit designed exclusively or a reconfigurable electronic circuit (an ASIC, an FPGA or the like). Moreover, the above-described functions of the respective circuits may be implemented by executing a predetermined program in an arithmetical operation processing circuit such as a CPU, and an ROM, an RAM, and the like.

### 2. Operation

Operation of the touch panel system configured as described above will be described.

### 2-1. Touch Detection Principle

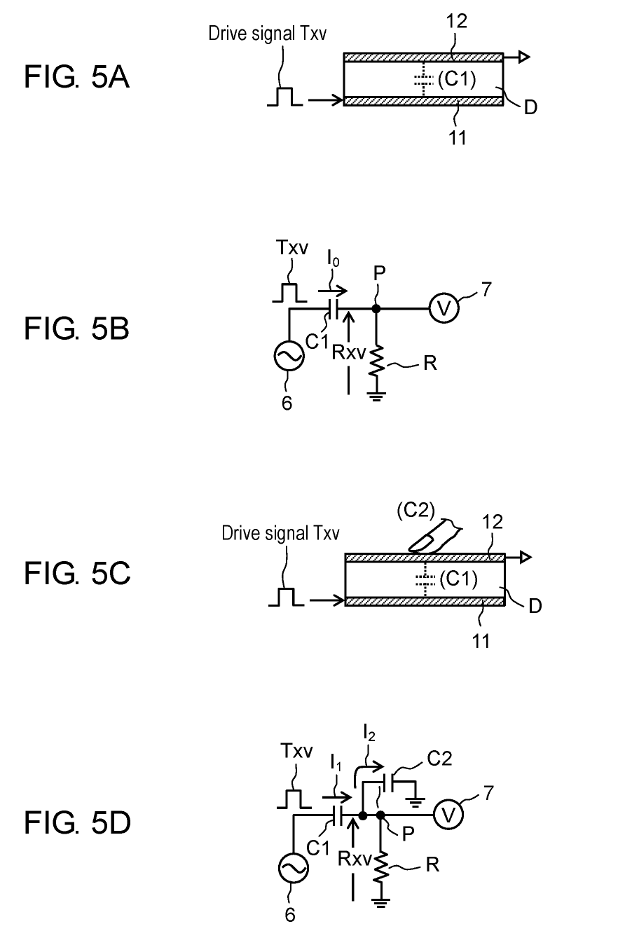

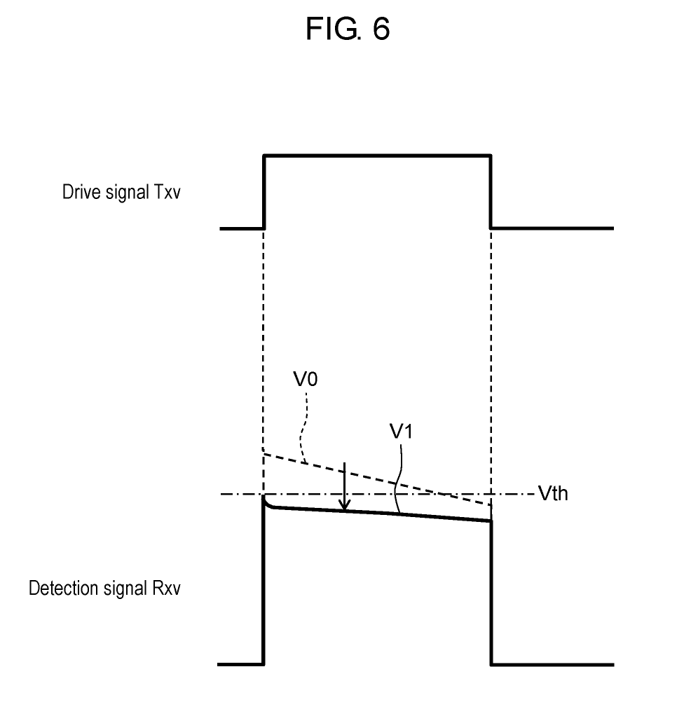

First, a principle of the touch detection in touch panel 100 will be described with reference to FIGS. 5A to 5D, 6. FIG. 5A is a diagram for describing a schematic configuration of touch sensor 20 in a state where the touch operation is not performed, and FIG. 5B is a diagram for describing an equivalent circuit of touch sensor 20 in the state where the touch operation is not performed. FIG. 5C is a diagram for describing the schematic configuration of touch sensor 20 in a state where the touch operation is performed, and FIG. 5D is a diagram for describing the equivalent circuit of touch sensor 20 in the state where the touch operation is performed. FIG. 6 is a diagram for describing change of the detection signal when the touch operation is not performed, and when the touch operation is performed.

In mutual capacity-type touch sensor 20 by the electrostatic capacity method, touch sensor 20, in the intersection portion (refer to FIG. 3) of a pair of drive electrode 11 and sensing electrode 12 intersecting with each other, the capacitive element is formed. That is, as shown in FIG. 5A, drive electrode 11, sensing electrode 12, and dielectric D configure capacitive element C1. As to capacitive element C1, in the equivalent circuit shown in FIG. 5B, one end of capacitive element C1 is connected to sensor drive circuit 6 as an AC signal source, and another end P is grounded through resistor R and is connected to signal detection circuit 7 as a voltage detector.

When drive signal Txv by the pulse voltage of the predetermined frequency of about several ten kHz to several MHz is applied to drive electrode 11 (the one end of capacitive element C1) from sensor drive circuit 6 as the AC signal source (refer to FIG. 6), the output waveform (the detection signal) Rxv as shown in FIG. 6 appears in sensing electrode 12 (other end P of capacitive element C1).

In a state where a finger does not come into contact with (or approach) the touch panel, current I0 in accordance with a capacity value of capacitive element C1 flows, accompanying charge/discharge with respect to capacitive element C1, as shown in FIG. 5B. A potential waveform at other end P of capacitive element C1 at this time becomes waveform V0 of detection signal Rxv shown in FIG. 6, which is detected by signal detection circuit 7 as the voltage detector.

On the other hand, in a state where the finger comes into contact with (or approaches) the touch panel, the equivalent circuit is configured such that capacitive element C2 formed by the finger is added to capacitive element C1 in series, as shown in FIG. 5C. In this state, in the equivalent circuit shown in FIG. 5D, currents I1, I2 flow, accompanying the charge/discharge with respect to capacitive elements C1, C2, respectively. The potential waveform at other end P of capacitive element C1 at this time becomes waveform V1 of detection signal Rxv shown in FIG. 6, which is detected by signal detection circuit 7 as the voltage detector. At this time, the potential at point P becomes a potential decided by values of currents I1, I2 flowing in capacitive elements C1, C2. Thus, an amplitude of waveform V1 has a value smaller than an amplitude of waveform V0 in the non-contact state.

Signal detection circuit 7 compares the potential of the detection signal output from each of sensing electrodes 12 with predetermined threshold voltage Vth, and if the potential of the detection signal is equal to or higher than this threshold voltage Vth, it is determined to be the non-contact state, and if the potential of the detection signal is lower than threshold voltage Vth, it is determined to be the contact state. In this manner, the touch detection is enabled. As another method for sensing a signal of change of the electrostatic capacity, there is a method of sensing a current or the like.

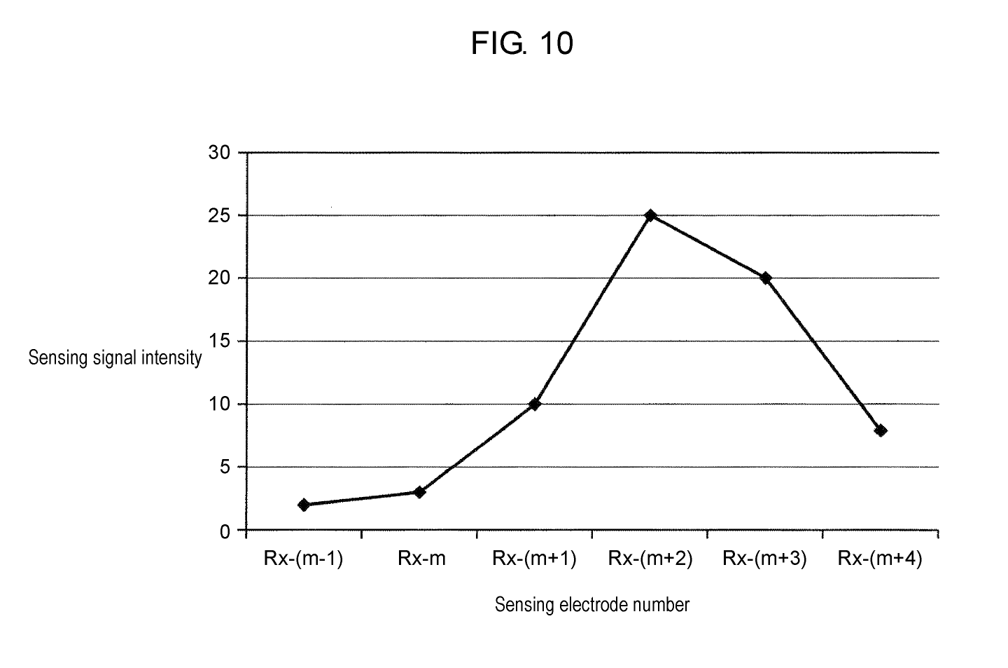

As described above, detection signal Rxv is induced by drive signal Txv from drive electrode 11. Here, in place of applying drive signal Txv to drive electrode 11 near sensing electrode 12, an electrode is arranged near sensing electrode 12 to change a potential of the electrode outside touch panel 100, by which similarly to drive signal Txv, the detection signal of sensing electrode 12 can be induced (refer to FIG. 10). The external electrode is, for example, transmission electrode 52 of electronic pen 50 (refer to FIG. 4). In touch panel 100, the detection signal induced, using the external electrode can also be detected by signal detection circuit 7 as with drive signal Txv.

### 2-2. Detection Method of Touch Position

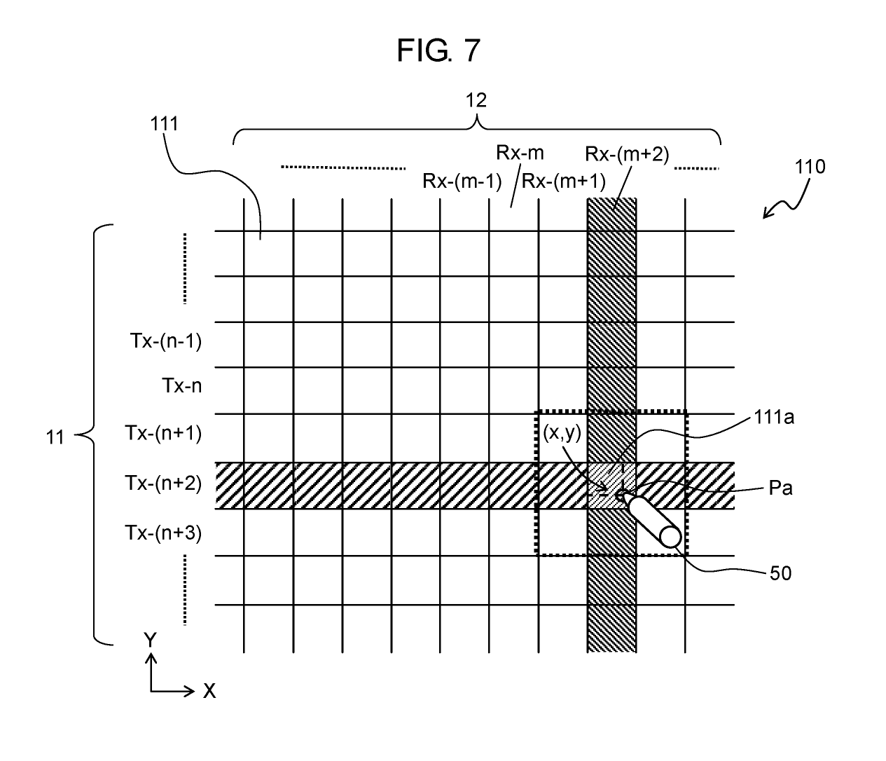

Next, a method for detecting the touch position at which touch panel 100 is touched will be described with reference to FIGS. 2 and 7. FIG. 7 is a diagram for describing detection operation of the touch position by touch panel 100.

In FIG. 7, Tx-n (n=1, 2, . . . , N) is a number of drive electrodes 11, and RX-m (M=1, 2, . . . , M) is a number of sensing electrodes 12. On the display surface of display 1 shown in FIG. 2, the plurality of drive electrodes 11 and sensing electrodes 12 are arranged so as to be superimposed, and detection region 110 configured to detect the touch operation is formed. Detection region 110 is divided by drive electrodes 11 and sensing electrodes 12 intersecting with one another in matrix, based on intersection region 111 where a pair of electrodes intersects with each other.

Signal detection circuit 7 in FIG. 2 acquires a detection value indicating the change of the electrostatic capacity in relevant intersection region 111 of a pair of electrodes, based on detection signal Rxv of one of sensing electrodes 12 induced by drive signal Txv from one of drive electrodes 11. The acquisition of the detection value by signal detection circuit 7 is performed in time division to each of drive electrodes 11 by scanning of drive signal Txv for each of the plurality of sensing electrodes 12. Thereby, the detection value in each of the plurality of intersection regions 111 arranged in matrix as shown in FIG. 7 can be acquired.

Position detection circuit 13 in FIG. 2 detects, for example, a maximum value within a predetermined range in detection region 110, and a peak value between adjacent intersection regions 111, based on distribution of the detection values of the plurality of intersection regions 111 arranged in matrix to detect intersection region 111a including touch position Pa with electronic pen 50 or the finger. Moreover, position detection circuit 13 performs gravity center calculation with respect to the detection values in a predetermined range such as, for example, three rows and three columns, five rows and five columns and the like, centering on detected intersection region 111a, by which coordinates (x, y) of touch position Pa in intersection region 111a as the center are arithmetically operated. In the figure, an X-axis direction of the coordinates is a direction where the plurality of sensing electrodes 12 are arranged side by side, and a Y-axis direction is a direction where the plurality of drive electrodes 11 are arranged side by side. This arithmetical operation of position detection circuit 13 allows the coordinates inside intersection region 111a to be accurately detected for touch position Pa.

### 2-3. Identification Operation of Electronic Pen

### 2-3-1. Overview of Operation

Touch panel 100 detects the touch operation with the finger or electronic pen 50 as described above. Even if a plurality of touch operations are simultaneously performed, the plurality of detection values are acquired for each of intersection regions 111 of the plurality of drive electrodes 11 and sensing electrodes 12 (refer to FIG. 7), by which each of the touch operations can be detected. Here, when a plurality of touch operations are performed in an electronic blackboard or the like, for example, it is desired that a color of a line or a line type displayed on touch panel 100 is changed for each of touching electronic pens 50, or that input information is individually stored. In this case, it is necessary to cause touch panel 100 to identify which electronic pen is electronic pen 50 performing the detected touch operation.

Consequently, in the touch panel system according to the present exemplary embodiment, the timing signal having the delay period in accordance with the ID of electronic pen 50 is transmitted from electronic pen 50 touching touch panel 100 to touch panel 100. Touch panel 100 is caused to identify electronic pen 50, based on the delay period of the received signal. Hereinafter, details of the operation of the present system will be described.

### 2-3-2. Detail of Operation

### (1) Flow of Operation

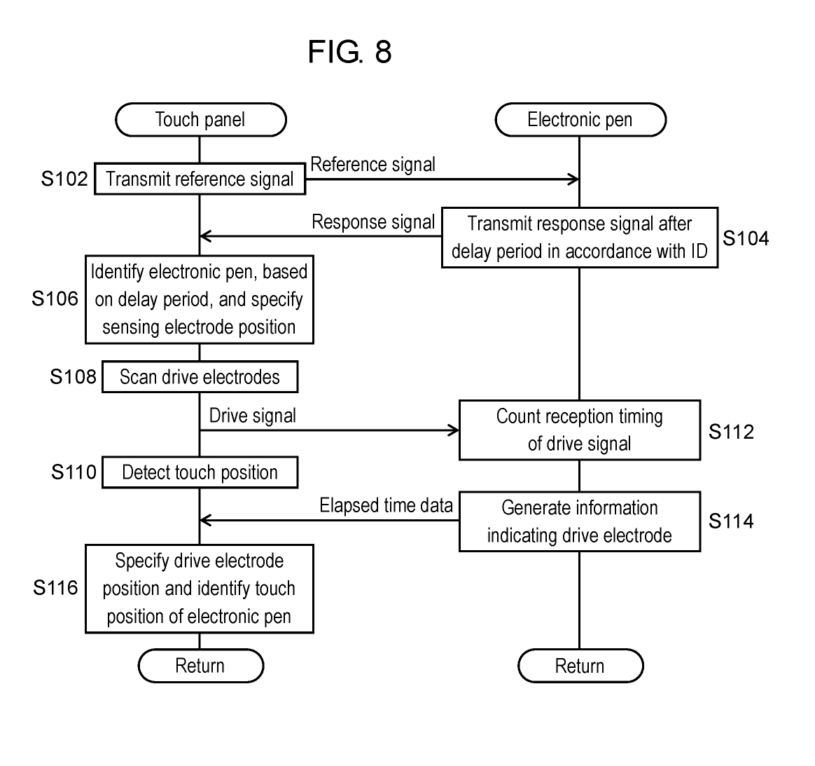

First, a flow of operation of the touch panel system according to the present exemplary embodiment will be described with reference to FIGS. 2, 4, and 8. FIG. 8 is a sequence diagram showing the flow of the operation of the touch panel system according to the present exemplary embodiment.

First, touch panel 100 transmits a reference signal, which is a timing signal indicating reference timing, to electronic pen 50 (S102). In step S102, signal control device 8 shown in FIG. 2 controls sensor drive circuit 6 to supply the reference signal to each of drive electrodes 11. Electronic pen 50 touching touch panel 100 receives the reference signal from drive electrodes 11 near the touch position through reception electrode 51 shown in FIG. 4.

Next, electronic pen 50 transmits the response signal, which is a timing signal indicating response timing of electronic pen 50, to touch panel 100 after the delay period in accordance with the ID of relevant electronic pen 50 has elapsed since the timing when the reference signal received (S104).

In step S104, first, signal detection circuit 53 shown in FIG. 4 amplifies the reference signal received from reception electrode 51, and shapes a waveform of the reference signal to output the resultant to timing generation circuit 54 as a synchronous signal. That is, reception electrode 51 receives the reference signal from touch panel 100 as the synchronous signal indicating synchronous timing with touch panel 100. Timing generation circuit 54 generates the response signal having, for example, a pulse waveform after the delay period in accordance with the ID of relevant electronic pen 50 has elapsed since the timing when the synchronous signal is input, and transmits the response signal from transmission electrode 52. Moreover, the synchronous signal is also input to timing counting circuit 55 to be a trigger of counting operation of timing counting circuit 55 described later.

Next, touch panel 100 receives the response signal from sensing electrode 12 near the touch position of electronic pen 50, and identifies the ID of electronic pen 50 that has transmitted the response signal, based on the delay period of the response signal from the timing indicating the reference signal (S106). Moreover, in step S106, touch panel 100 specifies sensing electrode 12 at the touch position of electronic pen 50, based on the response signal from electronic pen 50.

In step S106, first, signal detection circuit 7 shown in FIG. 2 detects the response signal from electronic pen 50, based on the change of the electrostatic capacity in sensing electrode 12. Signal control device 8 measures the delay period of the response signal, based on the detection result of signal detection circuit 7, reads the ID data table from the internal memory to identify the ID of electronic pen 50 corresponding to the measured delay period. Here, the response signal of electronic pen 50 is detected with a signal intensity of a maximum value (a peak value) in sensing electrode 12 at the touch position of electronic pen 50 (refer to FIG. 10). Signal control device 8 identifies that the touch position of electronic pen 50 whose ID has been identified is in a region of the sensing electrode where the response signal having the peak value has been detected.

Next, in touch panel 100, signal control device 8 shown in FIG. 2 controls sensor drive circuit 6 to output drive signal Txv so as to scan the plurality of drive electrodes 11 (S108). Signal detection circuit 7 detects the change of the electrostatic capacity with respect to each of drive electrodes 11 in time division for each of the plurality of sensing electrodes 12.

Next, as described above, position detection circuit 13 of touch panel 100 detects the touch position where the touch operation has been performed, based on the detection result of signal detection circuit 7 (S110). In step S110, as described above, position detection circuit 13 detects the touch position accurately enough to find the coordinates in the intersection region of drive electrode 11 and sensing electrode 12.

Meanwhile, electronic pen 50 touching touch panel 100 receives drive signal Txv supplied to the drive electrodes near the touch position through reception electrode 51 shown in FIG. 4 to count the timing of the reception (S112).

In step S112, first, signal detection circuit 53 of electronic pen 50 amplifies the drive signal received from reception electrode 51 and shapes a waveform of the drive signal to output to timing counting circuit 55 as a received signal. Timing counting circuit 55 counts an elapsed time from the timing when the synchronous signal is input to the timing when the signal intensity of the received signal becomes the maximum value (the peak value) with the synchronous signal from signal detection circuit 53 used as a trigger.

Next, data generation circuit 56 of electronic pen 50 generates information indicating drive electrode 11 at the touch position of electronic pen 50, based on the counting result of timing counting circuit 55 to transmit the information to touch panel 100 (S114). The counting result of timing counting circuit 55 corresponds to scanning timing of drive electrode 11 at the touch position of electronic pen 50, as described in detail later. Thus, in step S114, data generation circuit 56 generates elapsed time data indicating the counting result of timing counting circuit 55 as the information indicating drive electrode 11 at the touch position. In the present exemplary embodiment, data generation circuit 56 transmits the generated information to touch panel 100 together with ID information stored in the internal memory.

Next, touch panel 100 specifies a drive electrode position at the touch position of electronic pen 50 whose ID has been identified, based on the detected touch position and the information received from electronic pen 50 to identify the touch position of electronic pen 50 (S116). In step S116, signal control device 8 of touch panel 100 specifies drive electrode 11 at the touch position of electronic pen 50 whose ID has been identified, based on the received elapsed time data, and the scanning timing information stored in the internal memory. Signal control device 8 has already specified sensing electrode 12 at the touch position of electronic pen 50 in step S106. Thus, identified electronic pen 50 and intersection region 111 (refer to FIG. 7) of sensing electrode 12 and drive electrode 11 at the touch position are associated with each other, which allows signal control device 8 to identify the touch position of electronic pen 50 whose ID has been identified.

### (2) Detail of Processing

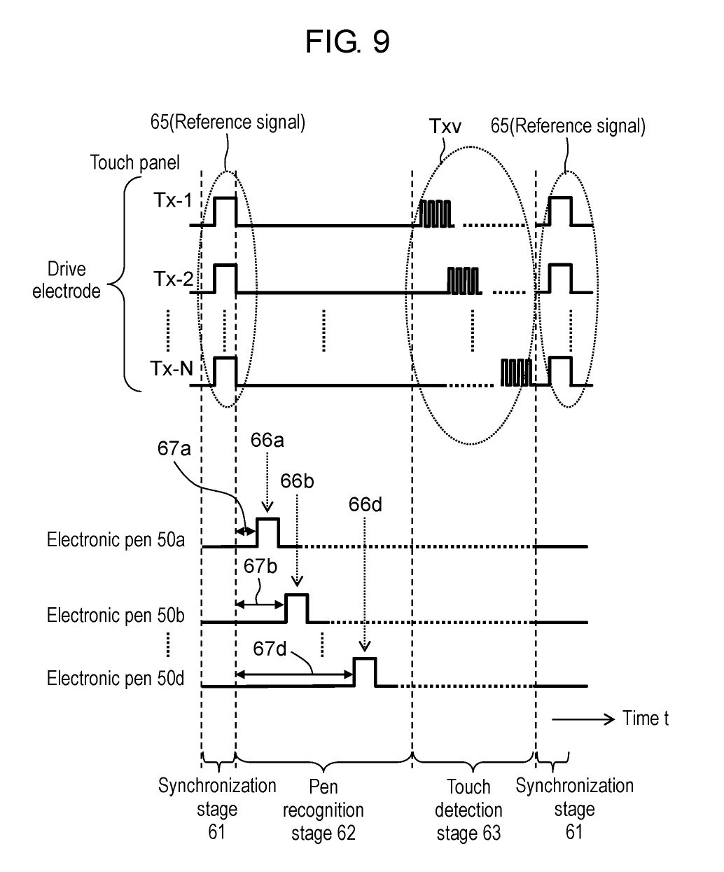

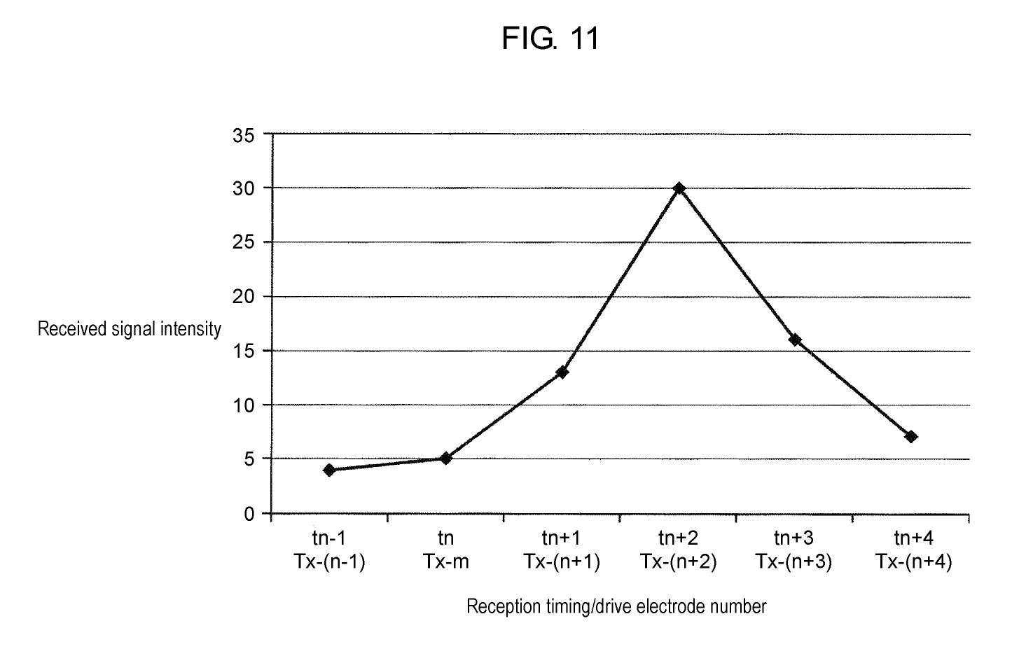

Hereinafter, referring to FIGS. 8 to 11, the processing in steps S102 to S116 in FIG. 8 will be described in more detail. FIG. 9 is a timing chart indicating identification operation when the plurality of electronic pens 50 touch panel 100. FIG. 10 is a graph showing one example of the sensing result of the response signal from electronic pen 50 in touch panel 100. FIG. 11 is a graph showing one example of a signal intensity of the drive signal received by electronic pen 50.

In FIG. 9, there are four electronic pens 50 touching touch panel 100 (electronic pens 50a to 50d), and the individual ID is assigned to each of electronic pens 50a to 50d.

As shown in FIG. 9, the operation of the touch panel system in the present exemplary embodiment is roughly divided into three stages of synchronization stage 61 (step S102 in FIG. 8), pen recognition stage 62 (steps S104 and S106 in FIG. 8), and touch detection stage 63 (steps S108 to S116 in FIG. 8). Touch panel 100 repeats a series of processing of these synchronization stage 61, pen recognition stage 62, and touch detection stage 63 in a constant cycle to thereby detect the touch positions while identifying the IDs of touching electronic pens 50.

First, in synchronization stage 61, touch panel 100 performs the processing in step S102 in FIG. 8, and reference signal 65 is synchronously output from all drive electrodes 11. In the case where the plurality of electronic pens 50a to 50d have touched touch panel 100, respective electronic pens 50a to 50d simultaneously receive reference signal 65 through respective reception electrodes 51 (FIG. 4) and reference signal 65 is synchronized. Signal detection circuit 53 of each of electronic pens 50a to 50d amplifies this reference signal 65 and shapes the waveform to generate the synchronous signal.

Next, in pen recognition stage 62, electronic pens 50a to 50d each perform processing in step S104 in FIG. 8. Timing generation circuit 54 of each of electronic pens 50a to 50d outputs detection pulse 66 as the response signal, based on the synchronous signal from signal detection circuit 53, after the delay period corresponding to the ID of each of electronic pens 50 one-to-one has elapsed.

In FIG. 9, the individual ID is assigned to each of four electronic pens 50a to 50d. At this time, electronic pen 50a outputs detection pulse 66a to touch panel 100 after shortest delay period 67a has elapsed since the reception of the reference signal (synchronous signal). Next, electronic pen 50b outputs detection pulse 66b to touch panels 100 after delay period 67b has elapsed since the reception of the reference signal. Similarly, electronic pen 50d outputs detection pulse 66d to touch panel 100 after delay period 67d has elapsed since the reception of the reference signal. As described above, the plurality of electronic pens 50a to 50d output, to touch panel 100, detection pulses 66a to 66d having the different delay periods in synchronization with the reference signal simultaneously received.

Moreover, in pen recognition stage 62, sensing electrode 12 of touch panel 100 receives detection pulse 66 output from each of electronic pens 50 (step S106 in FIG. 8). As described above, signal detection circuit 7 in FIG. 2 detects the detection pulse from transmission electrodes 52 of electronic pens 50 as in the case where the signal induced by drive signal Txv on sensing electrodes 12 is detected. At this time, the signal intensity of the detection signal from each of sensing electrodes 12 changes in accordance with a distance between the pen point of each of electronic pens 50, that is, transmission electrode 52 and relevant sensing electrode 12. One example of this is shown in FIG. 10.

FIG. 10 shows one example of a sensing result of the response signal from one of electronic pens 50 by signal detection circuit 7. In FIG. 10, a horizontal axis indicates the number of sensing electrodes, and a vertical axis indicates the detection signal intensity. As shown in FIG. 10, the response signal from one of electronic pens 50 is sensed in the plurality of sensing electrodes Rx-(m−1) to Rx-(m+4). That is, not only the sensing electrode at the touch position of electronic pen 50 but the sensing electrodes around the touch position receive the response signal. At this time, the detection signal intensity in the plurality of sensing electrodes Rx-(m−1) to Rx-(m+4) becomes larger in the sensing electrodes closer to transmission electrode 52 of electronic pen 50. In the example of FIG. 10, the detection signal intensity has a maximum value in sensing electrode Rx-(m+2). Thereby, touch panel 100 detects that the pen point, that is, transmission electrode 52 of electrode pen 50 exists on sensing electrode Rx-(m+2) in the processing in step S106 in FIG. 8.

In the case shown in FIG. 9, detection pulses 66a to 66d are output in different delay periods 67a to 67d from the reception of the reference signal, corresponding to four electronic pens 50a to 50d. These delay periods correspond to the IDs of respective electronic pens 50 one-to-one, and touch panel 100 can identify from which electronic pen 50 the detection signal captured by sensing electrode 12 at each of the timings from the reference signal transmission is the response signal. In other words, touch panel 100 identifies that the detection signal output in delay period 67a from the reception of the reference signal is the response signal from electronic pen 50a. Moreover, touch panel 100 identifies that the detection signal output in delay period 67b from the reception of the reference signal is the response signal from electronic pen 50b. The same is also applied to electronic pens 50c, 50d. Based on the intensity distribution of the detection signal as shown in FIG. 10, it is determined on which sensing electrode 12 in detection region 110 (refer to FIG. 7) of touch panel 100 each of the transmission electrode positions, that is, the position of the pen point of each of electronic pens 50 is, so that the touch position of the pen point of each of electronic pens and the position of sensing electrode 12 of touch panel 100 are associated.

Subsequently, in touch detection stage 63, touch panel 100 performs touch detection operation by processing in steps S108, S110 in FIG. 8. In step S108, as described above, drive signal Txv is supplied from sensor drive circuit 6 shown in FIG. 2 to drive electrodes Tx-1, Tx-2, . . . Tx-N so as to sequentially perform scanning. At this time, detection signal Rxv in sensing electrodes 12 changes in accordance with the presence or absence of the touch of a finger or electronic pen 50 on detection region 110 of touch panel 100. A change amount of detection signal Rxv in each of sensing electrodes 12 is measured in touch panel 100 as described above. This allows the touch position of the finger or electronic pen 50 on detection region 110 to be accurately arithmetically operated in touch panel 100 in step S110.

As described above, the touch position of electronic pen 50 is found. In normal case, by the above-described processing, the ID of touching electronic pen 50 can be identified, and the touch position of electronic pen 50 can be found sufficiently accurately. However, in some situations, the touch operations of the plurality of electronic pens 50 may be disabled to be distinguished. For example, when the pen points of the plurality of electronic pens 50 are simultaneously in same sensing electrode Rx-m, the touch operations cannot be distinguished. Consequently, in the present exemplary embodiment, processing in steps S112 to S116 shown in FIG. 8 is performed. That is, the processing in steps S112 to S116 is performed to associate the plurality of touch positions detected in step S110 with respective electronic pens 50, when the plurality of electronic pens 50 touch the same sensing electrode 12. Hereinafter, referring to FIGS. 8, 9, 11, details of the processing in steps S112 to S116 in FIG. 8 will be described.

In touch detection stage 63 in FIG. 9, each of electronic pens 50a to 50d receives drive signal Txv supplied to a vicinity of the touch position of each of electronic pens 50 from each of reception electrodes 51 shown in FIG. 4. In each of electronic pens 50, received drive signal Txv is transmitted to signal detection circuit 53 to be amplified, and shape the waveform, and becomes the received signal. The processing in step S112 by each of electronic pens 50 is performed by controlling timing counting circuit 55, based on this received signal.

In step S112 in FIG. 8, timing counting circuit 55 of each of electronic pens 50 counts the elapsed time until drive signal Txv is received from reception electrode 51 with the synchronous signal from signal detection circuit 53 used as the trigger. In synchronization stage 61 in FIG. 9, since all drive electrodes 11 of touch panel 100 outputs reference signal 65 simultaneously, respective electronic pens 50a to 50d receive reference signal 65 at the same timing, at whichever position on touch panel 100 they are located, and the timing of the trigger is the same. On the other hand, in touch detection stage 63, since drive signal Txv sequentially scans drive electrodes 11 in touch panel 100, the timing of the reception of drive signal Txv received by electronic pens 50a to 50d changes in accordance with the touch position of each of electronic pens 50. One example of the foregoing is shown in FIG. 11.

FIG. 11 shows one example of the signal intensity of drive signal Txv (received signal) that the specific electronic pen 50 receives. In FIG. 11, a vertical axis indicates the signal intensity of received drive signal Txv, and a horizontal axis indicates the elapsed time from reference signal 65.

In FIG. 11, the elapsed time on the horizontal axis corresponds to the scanning timing of drive electrodes 11 to which drive signal Txv is applied. As shown in FIG. 11, electronic pen 50 receives drive signal Txv applied to the plurality of drive electrodes Tx-n to Tx-(n+4). That is, electronic pen 50 receives not only drive signal Txv of the drive electrode at the touch position but drive signal Txv of the drive electrodes around the touch position. At this time, the signal intensity of the received signal from the plurality of drive electrodes Tx-n to Tx-(n+4) becomes larger in drive electrode 11 closer to transmission electrode 52 of electronic pen 50.

In the example of FIG. 11, electronic pen 50 having the received signal intensity shown in the graph is located on drive electrode 11 at the scanning timing when drive signal Txv is applied at timing tₙ₊₂ when the received signal intensity becomes highest, that is, is located on drive electrode Tx-(n+2). In order to detect this, timing counting circuit 55 in electronic pen 50 counts the elapsed time until the received signal intensity of drive signal Txv becomes largest with the synchronous signal used as the trigger. Thereby, drive electrode 11 where electronic pen 50 is located (in the example of FIG. 11, drive electrode Tx-(n+2)) can be specified.

Data generation circuit 56 in electronic pen 50 generates the elapsed time data indicating drive electrode 11 where electronic pen 50 is located, based on the elapsed time measured by timing counting circuit 55 as described above to transmit the elapsed time data to touch panel 100 (step S114 in FIG. 8).

Touch panel 100 receives the elapsed time data described above from the plurality of electronic pens 50a to 50d. Signal control device 8 of touch panel 100 specifies the position of drive electrode 11 scanned at the timing indicated by the elapsed time data as the drive electrode position at which the touch position of electronic pen 50 having the ID of the ID information is, based on the received elapsed time data and ID information, and the scanning timing information stored in the internal memory. In this manner, touch panel 100 specifies the drive electrode position in addition to the sensing electrode position of each of electronic pens 50. This enables the accurate touch position on touch panel 100 and each of electronic pens 50 to be easily associated with each other in step S116 in FIG. 8.

### 3. Effects and the Like

As described above, in the present exemplary embodiment, the touch panel system includes the plurality of electronic pens 50 and touch panel 100 configured to detect touch operation by electronic pens 50. Touch panel 100 includes touch sensor 20 and signal control device 8. Touch sensor 20 detects the touch position that each of electronic pens 50 touches. Signal control device 8 controls touch sensor 20 so that reference signal 65 indicating reference timing of touching electronic pen 50 is transmitted, and the response signal from electronic pen 50 having transmitted reference signal 65 is received. Each of electronic pens 50 includes reception electrode 51, timing generation circuit 54, and transmission electrode 52. Reception electrode 51 receives reference signal 65 from touch panel 100. Timing generation circuit 54 generates detection pulse 66, which is the response signal having the delay periods of the predetermined values different among the plurality of electronic pens 50 from the reference timing. Transmission electrode 52 transmits detection pulse 66 to touch panel 100 through touch sensor 20. Signal control device 8 identifies touching electronic pen 50, based on the delay period of detection pulse 66 received from each of electronic pens 50.

According to the above-described touch panel system, when the touch operation is performed by different electronic pens 50, touching electronic pens 50 are identified, based on the delay periods of the individual detection pulses 66, so that the touch operation by each of electronic pens 50 can be identified.

Moreover, in the present exemplary embodiment, the plurality of electronic pens transmit the response signal in the delay periods different from one another with respect to the reference signal from touch panel 100, which enables touch panel 100 to individually manage the sensing electrode positions where respective electronic pens 50 are in contact with touch panel 100. That is, touch panel 100 determines the position where electronic pen 50 comes into contact with touch panel 100, based on the received response signal, and manages the information for specifying by which electronic pen 50 the contact has been performed in accordance with the difference in the delay period of the response signal transmitted from electronic pen 50. This enables touch panel 100 to identify the individual electronic pens 50, even if the contacts are performed by the plurality of electronic pens 50.

Moreover, in the present exemplary embodiment, touch sensor 20 may receive the response signal from sensing electrode 12 at the touch position that electronic pen 50 touches. In this case, signal control device 8 identifies that touching electronic pen 50 is in sensing electrode 12 at the touch position, based on the response signal received from the touch position. Electronic pen 50 receives the response signal from sensing electrode 12 at the touch position that electronic pen 50 touches and identifies that touching electronic pen 50 is in sensing electrode 12 at the touch position, by which electronic pen 50 and the touch position are associated with each other within the range where sensing electrode 12 is (refer to FIG. 7).

Moreover, in the present exemplary embodiment, touch sensor 20 may include the plurality of drive electrodes 11 and sensing electrodes 12 intersecting with one another. In this case, touch sensor 20 detects the touch position, based on the change of the electrostatic capacity between drive electrodes 11 and sensing electrodes 12. Signal control device 8 simultaneously outputs reference signal 65 to drive electrode 11 to transmit reference signal 65 to touching electronic pen 50, and controls touch sensor 20 so that the response signal from electronic pen 50 to which reference signal 65 has been transmitted is received in sensing electrode 12. This allows touch panel 100 to perform transmission/reception of the signals with respect to electronic pen 50 by drive electrodes 11 and sensing electrodes 12 to detect the touch position of touch sensor 20 without providing the hardware configuration dedicated for electronic pen 50. This can easily implement the present touch panel system.

### Other Exemplary Embodiments

As described above, the first exemplary embodiment has been described as an illustration of the technique disclosed in the present application. However, the technique in the present disclosure is not limited thereto, but can also be applied to exemplary embodiments to which modifications, replacements, additions, omissions and the like are made. Moreover, respective components described in the above-described first exemplary embodiment can be combined to constitute a new exemplary embodiment. Hereinafter, other exemplary embodiments will be exemplified.

In the first exemplary embodiment, for the ID identification of the plurality of electronic pens 50, the processing in steps S102 to S116 in FIG. 8 is performed so that both the sensing electrode position and the drive electrode position are specified. However, electronic pen 50 need not perform the processing steps of S112, S114. In this case, touch panel 100 identifies the touch position of electronic pen 50 whose ID is identified without specifying drive electrode 11 where the pen point of electronic pen 50 is, in step S116.

Especially, in the case where a large touch panel such as the electronic blackboard is erected for use (refer to FIG. 1), if an electrode arrangement is employed, in which sensing electrodes 12 extend in the vertical direction and are arrayed in the horizontal direction, it can be considered that a possibility that the plurality of electronic pens come into contact with the same sensing electrode is extremely low. That is, in the identification of the ID of each of electronic pens 50, only the sensing electrode position of each of electronic pens 50 is specified, which enables the touch position of electronic pen 50 to be identified substantially accurately. In other words, in the case where only the sensing electrode position of each of electronic pens 50 is specified, as long as the plurality of electronic pens 50 comes into contact with the same sensing electrode 12, it is hard to distinguish electronic pens 50 from one another. However, in an actual use, such a situation rarely occurs. Even if such a situation occurs, since in the present touch panel system, the identification operation of electronic pens 50 is periodically performed, as shown in FIG. 9, electronic pens 50 can be identified again when the positions of electronic pens 50 change during use. Therefore, timing counting circuit 55 and data generation circuit 56 can be omitted from electronic pen 50 in some purposes.

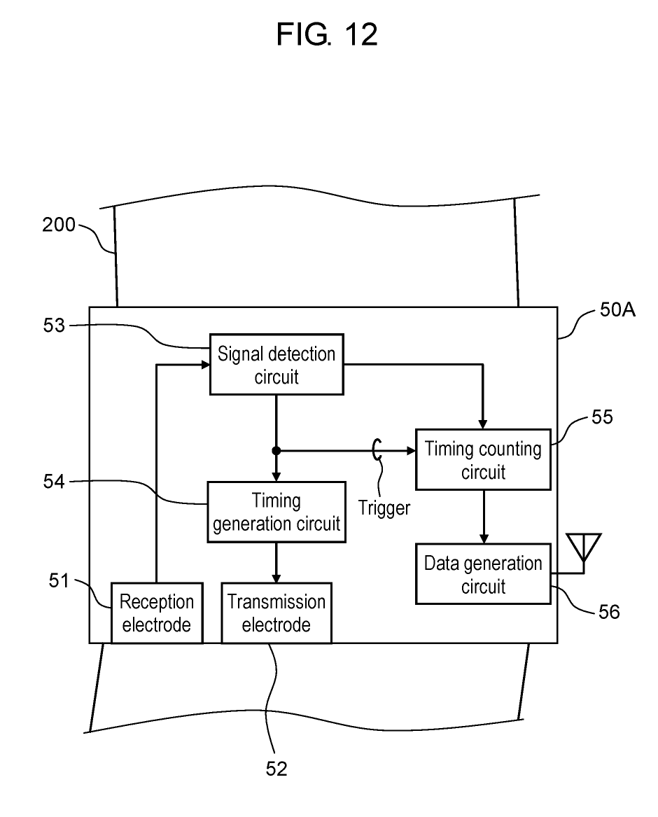

Moreover, while in the first exemplary embodiment, electronic pen 50 is described as the input device configured to input the touch operation to touch panel 100, the input device is not limited thereto, but may be, for example, a wearable terminal configured to be put on a hand of the user, such as a ring, a wristband and the like. Hereinafter, referring to FIG. 12, a description will be given.

FIG. 12 is a block diagram showing a configuration of the wearable terminal in another exemplary embodiment. Wearable terminal 50A is one example of the input device configured to be attached to wrist 200 of the user for use, and to input touch operation by the user touching touch panel 100. A circuit configuration of wearable terminal 50A is similar to that of electronic pen 50 in the first exemplary embodiment. In wearable terminal 50A, reception electrode 51 and transmission electrode 52 are disposed in contact with wrist 200 or the like of the user. Thereby, when the user touches touch panel 100, the signal of drive electrode 11 of touch panel 100 can be received by reception electrode 51 through a body of the user (a dielectric), and the signal can be transmitted to sensing electrode 12 of touch panel 100 from transmission electrode 52. Thus, wearable terminal 50A transmits the response signal of the delay period corresponding to the ID one-to-one, which enables touch panel 100 to identify wearable terminal 50A.

Moreover, in the first exemplary embodiment, data generation circuit 56 generates the elapsed time data indicating the counting result of timing counting circuit 55. The information generated by data generation circuit 56 is not limited to the elapsed time data, but, for example, data indicating the number of drive electrode 11 at the scanning timing corresponding to the elapsed time counted by timing counting circuit 55 may be generated. In this case, scanning timing information indicating the scanning timing of respective drive electrodes 11 is beforehand stored on a basis of the number of drive electrode 11 in the internal memory of data generation circuit 56. Moreover, data generation circuit 56 may generate, for example, information for designating the color of the line or the line type drawn by electronic pen 50 on the display surface of touch panel 100. Moreover, information regarding the touch operation of electronic pen 50, such as implementing a function of electronic pen 50 drawing the line on the display surface, implementing a function of erasing an image on the display surface, and the like may be generated. The above-described information can also be transmitted from data generation circuit 56 to touch panel 100.

Moreover, while in the first exemplary embodiment, the transmitter of electronic pen 50 includes transmission electrode 52 and various types of transmission means for transmitting the information generated by data generation circuit 56, the transmitter of electronic pen 50 may include only transmission electrode 52. In this case, touch panel 100 may not be provided with the communicator (not shown), either. The information generated by data generation circuit 56 may be transmitted to touch panel 100, using transmission electrode 52. For example, the response signal may be modulated, based on a code indicating the information generated by data generation circuit 56, by which the information generated by data generation circuit 56 may be added to the response signal to transmit the same to touch panel 100.

Moreover, while in the first exemplary embodiment, electronic pen 50 receives the reference signal from reception electrode 51, the present disclosure is not limited to reception electrode 51, but the reference signal may be received, using another receiver. For example, electronic pen 50 may receive the reference signal in wired connection with touch panel 100. In this case, since the synchronous signal from touch panel 100 can be transmitted to each of electronic pens 50 through cables, it is unnecessary that reference signal 65 be applied to drive electrodes 11 to be received by reception electrode 51 of each of electronic pens 50. Similarly, if touch panel 100 is configured such that the signal to synchronize with electronic pens 50 is transmitted to electronic pens 50 without using drive electrodes 11, for example, by using an optical signal, ultrasonic waves or the like, reference signal 65 need not be applied to drive electrodes 11. Moreover, in place of the reference signal transmitted to electronic pens 50 from touch panel 100, a synchronous signal simultaneously transmitted to touch panel 100 and electronic pens 50 from an external device (an external server or the like) may be used. Touch panel 100 and electronic pens 50 may be synchronized. In this case, each of electronic pens 50 receives a synchronous signal indicating timing synchronous with touch panel 100, and generates a timing signal having a delay period corresponding to the ID from the timing of the synchronous signal to transmit the timing signal to touch panel 100. Signal control device 8 of touch panel 100 identifies touching electronic pen 50, based on the delay period of the timing signal received from each of electronic pens 50.

Moreover, while in the first exemplary embodiment, as the display, the liquid crystal panel is used, the display may not be a liquid crystal panel. For example, an organic EL display, an LED display, or an electronic paper display may be employed.

While touch panel 100 in the above-described exemplary embodiment is a mutual capacity-type touch panel device, the present disclosure is not limited thereto. That is, even when the touch panel device is of self-capacity type, or of an optical type, IDs of individual digital pens can be managed in accordance with a difference in a delay signal transmitted from electronic pens.

The present disclosure can be applied to a touch panel device having an electrostatic capacity coupling-type input function such as, for example, an electronic blackboard.

What is claimed is:

1. A touch panel system comprising:
a plurality of input devices; and
a touch panel device configured to detect touch operations by the respective input devices,
the touch panel device including:
a touch sensor configured to detect touch positions where the input devices have respectively touched; and
a controller that causes the touch sensor to transmit to the input devices, which have touched the touch panel device, a reference signal indicative of a reference timing and receive response signals from the input devices that have received the reference signal;
each of the input devices including:
a receiver configured to receive the reference signal from the touch panel device;
a signal generator configured to generate a response signal having a delay period of a predetermined value different from one another among the plurality of input devices from the reference timing; and
a transmitter configured to transmit the response signal to the controller via the touch sensor, wherein
the controller identifies each of the input devices which have touched the touch panel device, based on the delay period of the response signals received from the respective input devices.

2. The touch panel system according to claim 1, wherein
the touch panel device transmits the reference signal to the input devices, which have touched the touch panel device, via the touch sensor.

3. The touch panel system according to claim 1, wherein
the touch sensor receives the response signals at the touch positions where the input devices have respectively touched, and
the controller identifies that the input devices, which have touched the touch panel device, are at the touch positions respectively, based on the response signals received at the touch positions.

4. The touch panel system according to claim 1, wherein
the touch sensor includes a plurality of first electrodes and a plurality of second electrodes, the plurality of first electrodes and the plurality of second electrodes intersecting with one another,
the touch sensor detects the touch positions, based on changes in capacitance between the plurality of first electrodes and the plurality of second electrodes, and
the controller causes the touch sensor to transmit the reference signal to the input devices, which have touched the touch panel device, by outputting the reference signal to the plurality of first electrodes in unison and receive the response signals from the input devices, which have received the reference signals, at the plurality of second electrodes.

5. The touch panel system according to claim 4, wherein
the controller of the touch panel device outputs drive signals for scanning and driving the plurality of first electrodes,
the receivers of the input devices receive the drive signals from the first electrodes of the touch panel device, and
each of the input devices further includes a timing counter configured to count a timing of reception of the drive signal.

6. The touch panel system according to claim 1, wherein
each of the input devices further includes a data generator configured to generate information regarding the touch operation by the corresponding input device, and
the transmitter transmits the information generated by the data generator to the touch panel device.

7. The touch panel system according to claim 1, wherein
each of the input devices is configured by an electronic pen.

8. The touch panel system according to claim 1, wherein
each of the input devices is configured by a wearable terminal.

9. A touch panel device configured to detect touch operation by an input device, the touch panel device comprising:
a touch sensor configured to detect a touch position where the input device has touched; and
a controller configured to cause the touch sensor to transmit to the input device, which has touched the touch panel device, a reference signal indicative of a reference timing and receive a response signal from the input device which has received the reference signal,
wherein the controller identifies the input device which has touched the touch panel device, based on a delay period of the received response signal, the delay period being a delay period from reference timing indicated by the transmitted reference signal.

10. The touch panel device according to claim 9, being configured to transmit the reference signal to the input device, which has touched the touch panel device via the touch sensor and receive the response signal from the input device which has received the reference signal via the touch sensor.

11. The touch panel device according to claim 9, further comprising
a display configured to display an image, the display being superimposed on the touch sensor,
wherein the controller controls the image displayed in the display, based on information input by the identified input device.

12. An input device configured to input a touch operation by touching a touch panel device configured to detect the touch operation, the input device comprising:
a receiver configured to receive a reference signal indicative of reference timing from the touch panel device;
a signal generator configured to generate a response signal having a delay period of a predetermined value from the reference timing; and
a transmitter configured to transmit the response signal to the touch panel device.
